(19) United States
(12) Patent Application Publication
(10) Pub. No.: US 2024/0337536 A1
(43) Pub. Date: Oct. 10, 2024

(54) ON-CHIP FOURIER TRANSFORM SPECTROMETER BASED ON DOUBLE-LAYER HELICAL WAVEGUIDE

(71) Applicant: Shanghai Jiao Tong University, Shanghai (CN)

(72) Inventors: Liangjun LU, Shanghai (CN); Tianyu CHENG, Shanghai (CN); Linjie ZHOU, Shanghai (CN); Jianping CHEN, Shanghai (CN); Jiao LIU, Shanghai (CN)

(21) Appl. No.: 18/413,015

(22) Filed: Jan. 15, 2024

Related U.S. Application Data
(63) Continuation of application No. PCT/CN2021/123482, filed on Oct. 13, 2021.

(30) Foreign Application Priority Data
Jul. 15, 2021 (CN) 202110801046.3

(51) Int. Cl. G01J 3/45; G01J 3/453; G02F 1/21; G02F 1/225

(52) U.S. Cl. CPC G01J 3/45; G02F 1/212; G02F 1/2252; G01J 2003/4538

(57) ABSTRACT

An on-chip Fourier transform spectrometer based on a double-layer spiral waveguide comprises, in order, a waveguide input coupler, a 1×N optical splitter, N double-layer waveguide Y-branch structures, N double-layer spiral waveguides with incremental lengths, N double-layer waveguide Y-branch structures arranged in opposite directions, and N germanium-silicon detectors. The group index difference between the odd mode and the even mode in the double-layer waveguide makes the double-layer spiral waveguide function like an asymmetric Mach-Zehnder interferometer. N double-layer spiral waveguides with incremental lengths are used to achieve a spatial heterodyne based Fourier transform spectrometer. Spectral reconstruction from the measured interference fringes can be achieved by a regression algorithm. The invention meets the application need for miniaturization and portability of Fourier transform spectrometers, and has lower temperature sensitivity compared with the existing on-chip spectrometers on the silicon platform.

### CROSS-REFERENCE TO RELATED APPLICATIONS

The subject application is a continuation of PCT/CN2021/123482 filed on Oct. 13, 2021, which in turn claims priority on Chinese Patent Application No. 202110801046.3 filed on Jul. 15, 2021. The contents and subject matters of the PCT international stage application and Chinese priority application are incorporated herein by reference.

### TECHNICAL FIELD

The present invention belongs to the field of optical detection and sensing and in particular relates to an on-chip Fourier transform spectrometer based on a double-layer spiral waveguide.

### BACKGROUND ART

Infrared spectrometer is one of the most effective means to analyze and identify the molecular structure and chemical composition by using the absorption characteristics in the infrared wavelength range. Conventional Fourier transform spectrometers, which are typically made of discrete optical elements and mechanical components, are expensive, large in size, and inconvenient to carry and use. Michelson interferometers, for example, require changing the optical path difference by moving a mirror to produce interference fringes. In order to achieve compact volume, reduced cost and power consumption, and convenience to carry and use, miniaturized on-chip Fourier transform spectrometer has received extensive research and attention. MEMS-based Fourier transform spectrometers have been reported to achieve system miniaturization (see Opt. Lett., vol. 24, no. 23, pp. 1705-1707, 1999), but still comprise relatively fragile moving components. It is preferred to include no movable components.

In recent years, it has shown continuous progress of integrated photonic technology, especially the rapid development of silicon photonic technology, where the device integration scale and functional complexity in the photonic chips continue to grow. The applications of integrated photonic chips are not limited to optical communications, but also expand to automatic driving, photonic neural networks, quantum signal processing, biosensing, etc. The research of on-chip Fourier transform spectrometer has gradually become a hot spot. The device has no moving components with the advantages of small size, light weight, power efficiency, and low cost. It can also meet needs of Lab-on-a-chip applications in the fields such as biological detection and cosmic particle detection in the future.

Currently, the on-chip Fourier transform spectrometers can be divided into two main categories: Standing Wave Integrated Fourier Transform (SWIFT) spectrometer and Spatial Heterodyne Spectrometer (SHS).

A SWIFT-based spectrometer generates standing wave interference fringes from two oppositely propagating beams in a waveguide and receives the interference pattern scattered from the waveguide by arranging an array of detectors above the waveguide. Such a device can achieve high resolution with a small chip size. However, the research work by E. Coarer etc. has shown that the interference fringe has a spacing of λ/2n_{eff}, much smaller than the pitch of existing detector arrays. Thus, the measured interferogram is undersampled, resulting in a limited spectral bandwidth. See Nat. Photon., vol. 1, p. 473-478 (2007). Also, in the existing solutions, the interference fringes can be received by placing an infrared camera above the waveguide, which is difficult to miniaturize the whole system.

Spectrometers based on SHS structures typically produce spatially distributed interference patterns by varying the arm length difference or optical path difference of an asymmetric Mach-Zehnder interferometer (MZI). There are currently two main ways to achieve optical path difference modulation, one is to change the effective optical path of one of the arms by electro-optic and thermo-optic effects, and the other is to generate an interference pattern by a series of MZI arrays with different optical path differences. Based on the first method, the waveguide refractive index and length modulated and generated by the thermo-optic or electro-optic effect have small changes and the power consumption is large. In addition, due to the introduction of thermal modulation, the thermo-optic nonlinearity, thermal expansion, and dispersion caused by heating introduce errors to the spectral reconstruction, and the change of ambient temperature also affects the device heating and test results. The second way may increase the number of MZI to improve the resolution of a given spectral bandwidth, but it also fails to solve the problem of thermal sensitivity. When the temperature changes, due to the change of waveguide refractive index and waveguide length, it leads to the shift of the final interference fringes, affecting the accuracy of spectral reconstruction. In addition, since different MZI arm lengths introduce different losses, the greater the length difference, the greater the losses, ultimately leading to a smaller extinction ratio.

In addition, in recent years, many researchers have proposed different solutions to improve the performance of the on-chip Fourier transform spectrometers, such as integrating optical switches on MZI interferometric arms to achieve digital modulation of optical path difference (see Nat. Commun., Vol. 9 (2018)), reducing the number of MZI by using the two polarization states of the waveguides (see Opt. Lett., Vol. 44, No. 11, pp. 2923-2926 (2019)), and reducing temperature sensitivity by using temperature-dependent calibration matrices (see Opt. Lett., Vol. 42, No. 11, pp. 2239-2242 (2017)).

It can be seen that the on-chip Fourier transform spectrometer based on integrated optical waveguides has become a research hotspot since it was proposed in 2007, and has been continuously improved, however it is still limited by many factors such as temperature sensitivity. The current on-chip Fourier transform spectrometers are far from the existing advanced desktop Fourier transform spectrometers in terms of effective resolution points, spectral range, practicality, etc.

### SUMMARY OF THE INVENTION

To overcome the deficiencies of the current technology, the present invention provides an on-chip Fourier transform spectrometer based on a double-layer spiral waveguide. The present invention uses the group index difference of odd and even modes in a double-layer spiral waveguide to construct an asymmetric Mach-Zehnder interferometer structure, which has the advantages of low environmental temperature sensitivity, high output extinction ratio, etc. In addition, the chip resolution is effectively improved by compressed sampling and spectral reconstruction algorithm in the present invention.

The technical solution of the present invention is as follows.

An on-chip Fourier transform spectrometer based on a double-layer spiral waveguide comprises a waveguide input coupler, a 1×N optical splitter, N double-layer waveguide Y-branch structures, N double-layer spiral waveguides, N double-layer waveguide Y-branch structures arranged in opposite directions, and N germanium-silicon detectors;
an output end of the waveguide input coupler is connected to an input end of the 1×N optical splitter; N output ends of the 1×N optical splitter are respectively connected to an input end of the N double-layer waveguide Y-branch structures; output ends of the N double-layer waveguide Y-branch structures are connected to input ends of the N double-layer spiral waveguides; output ends of the N double-layer spiral waveguides are connected to input ends of N double-layer waveguide Y-branch structures arranged in opposite directions; one output end of the N double-layer waveguide Y-branch structures arranged in opposite directions is connected to an input end of the N germanium-silicon detectors;
the N double-layer spiral waveguides are composed of N double-layer spiral waveguides with linearly incremental lengths; the two layers of waveguides of each double-layer spiral waveguide are parallel to each other, and the width and height of each double-layer spiral waveguide are consistent with the width and height of the corresponding double-layer waveguide Y-branch structure; the double-layer spiral waveguides have even and odd modes with different group index, so that the output ends have different optical path differences OPDᵢ=Lᵢ(n_{gO}−n_{ge}), wherein n_{go} and n_{ge} are group indices of the odd mode and even mode excitated in the double-layer spiral waveguide respectively, and Lᵢ is the length of an i^{th} double-layer spiral waveguide.

In the present invention, the waveguide input coupler adopts a butt-coupling structure or an optical grating structure; and optical spectral signal to be measured is input into the chip by an optical fiber.

In the present invention, the 1×N optical splitter achieves an equal division of the incident optical power by using a cascaded 1×2 splitter structure of log₂N stages such as a Y branch, a directional coupler or a multi-mode interferometer (MMI) structure, or using a 1×N multi-mode interference structure.

In the present invention, the N double-layer waveguide Y-branch structures and the N double-layer waveguide Y-branch structures arranged in opposite directions are both composed of N double-layer waveguide Y-branch structures with the same structure; the Y-branch structures are composed of upper and lower waveguides with the same width, the same thickness and parallel to each other at a beam combination position, namely, the double-layer waveguides together constitute a beam combination end; the upper and lower vertical waveguides are gradually separated at the branch in the horizontal direction, each becoming a single-layer waveguide, achieving the splitting of incident light and the conversion of the waveguide from a double layer to a single layer.

In the present invention, the N germanium-silicon detectors convert optical power signals into electrical signals, such as using germanium-silicon PIN structures.

In the present invention, the N double-layer waveguide Y-branch structures, N double-layer spiral waveguides with incremental lengths and N double-layer waveguide Y-branch structures arranged in opposite directions are similar to an asymmetric Mach-Zehnder interferometer array structure with incremental optical path differences, which function as a Fourier transform spectrometer. The double-layer spiral waveguide array constitutes an array of interferometer structure with different optical path differences; and the optical path difference variation is introduced by the variation of the spiral waveguide length.

In a spectrum test, a calibration matrix is firstly obtained by using the optical power received by the germanium-silicon detector array when a continuous wave laser source is input to the chip and scans the wavelength in the wavelength range. When testing unknown optical spectral signal, the optical power measured by the germanium-silicon detector array and the compressive sensing algorithm are used. With optimized regularization parameters and hyperparameters set to reconstruct the spectrum, an improved spectral resolution is obtained.

The present invention has the following beneficial effects compared to the prior art.
1. The double-layer spiral waveguide structure of the device of the present invention can use silicon nitride material, which has a small thermo-optic coefficient. Due to the close distribution of the odd and even modes in the double-layer structure, the thermo-optic coefficients of the odd and even modes in the double-layer spiral waveguide are close, and the effective refractive index changes of the two modes can be approximately canceled when the temperature changes. Therefore, the structure has the advantage of low temperature sensitivity.
2. In the double-layer spiral waveguide structure of the present invention, the propagation length of the odd and even modes is the same, and the mode distribution of the odd and even modes is similar. Therefore, the losses of the two modes are similar, and the extinction ratio of the output interference fringes is higher.

### BRIEF DESCRIPTION OF THE DRAWINGS

FIG. 1 is a structural schematic diagram showing the Fourier transform spectrometer on a silicon substrate of the present invention.

FIG. 2 is a schematic diagram showing the double-layer waveguide Y-branch structure in one embodiment of the present invention.

FIG. 3 is a structural schematic diagram showing the top view of the double-layer spiral waveguide of the present invention.

FIG. 4 is a structural schematic diagram showing the side view of the double-layer spiral waveguide of the present invention.

FIG. 5 is a schematic diagram showing the operation of the on-chip Fourier transform spectrometer of the present invention when N=32.

FIG. 6 is a schematic diagram showing an exemplary calibration matrix A in one embodiment of the present invention, wherein the vertical axis refers to the output port.

FIG. 7 is an exemplary diagram showing the recovery spectrum in one embodiment of the present invention, wherein the vertical axis refers to the proportion.

### DETAILED DESCRIPTION OF THE INVENTION

The technical solutions and key advantages of the present invention are further explained below, while more detailed description of the present invention is rendered by reference to the attached drawings and embodiments. The following specific embodiments are for illustrative purposes only and are not intended to limit the scope of the present invention. At the same time, the technical features involved in various embodiments can be combined with each other as long as they do not conflict with each other.

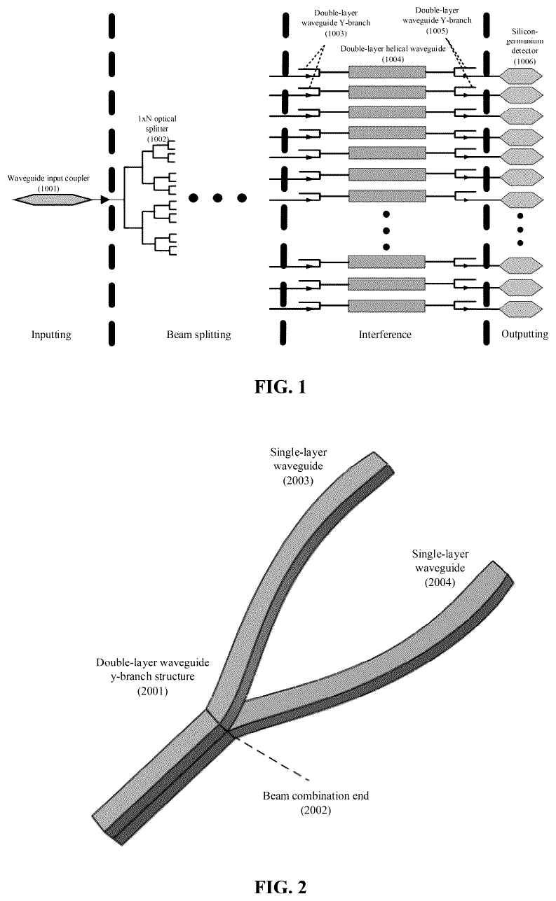

As shown in FIG. 1, the on-chip Fourier spectrometer based on the double-layer spiral waveguide of the present invention comprises, in order, a waveguide input coupler 1001, a 1×N optical splitter 1002, N double-layer waveguide Y-branch structures 1003, N double-layer spiral waveguides 1004 with incremental lengths, N double-layer waveguide Y-branch structures 1005 arranged in opposite directions, and N germanium-silicon detectors 1006, and is prepared on a silicon substrate, wherein the waveguide core is made of silicon nitride. An output end of the waveguide input coupler 1001 is connected to an input end of the 1×N optical splitter 1002; N output ends of the 1×N optical splitter 1002 are respectively connected to an input end of the N double-layer waveguide Y-branch structures 1003; output ends of the N double-layer waveguide Y-branch structures 1003 are connected to input ends of the N double-layer spiral waveguides 1004; output ends of the N double-layer spiral waveguides 1004 with incremental lengths are connected to input ends of N double-layer waveguide Y-branch structures 1005 arranged in opposite directions; and one output end of the N double-layer waveguide Y-branch structures 1005 arranged in opposite directions is connected to an input end of the N germanium-silicon detectors 1006.

One embodiment of the present invention uses N=32, the structure of which is shown in FIG. 4.

The waveguide input coupler 1001 adopts a butt-coupling structure, and the purpose thereof is to couple optical spectral signal to be measured into a chip by an optical fiber. An output end of the waveguide input coupler is connected to an input end of a 1×32 optical splitter.

The 1×32 optical splitter 1002 employs a 5-stage cascaded 1×2-splitter architecture in which the 1×2-splitter is a multi-mode interferometer (MMI).

The 32 double-layer waveguide Y-branch structures 1003 and the 32 double-layer waveguide Y-branch structures 1005 arranged in opposite directions are each composed of N double-layer waveguide Y-branch structures 2001 of the same structure. The structure of the Y-branch structure 2001 is as shown in FIG. 2, and the Y-branch structure is composed of two waveguides with a width of 1 μm and a thickness of 400 nm placed vertically at a beam combination position. The distance between the two waveguides in the vertical direction is set to be 250 nm. Namely, the double-layer waveguides together constitute a beam combination end 2002. At the branch, the upper and lower vertical waveguides are gradually separated in the horizontal direction, each becoming a single-layer waveguide 2003, 2004, respectively, achieving the splitting of incident light and the conversion of the waveguide from a double layer to a single layer. 32 output ends of the 1×32 optical splitter 1002 are respectively connected to an input end of the 32 double-layer waveguide Y-branch structures 1003. The output ends of the 32 double-layer waveguide Y-branch structures 1003 are connected to the input ends of the 32 double-layer spiral waveguides 1004 with incremental lengths. The output ends of 32 double-layer spiral waveguides 1004 with incremental lengths are connected to the input ends of 32 double-layer waveguide Y-branch structures 1005 arranged in opposite directions.

The 32 double-layer spiral waveguides 1004 have incremental lengths, and is composed of 32 double-layer silicon nitride spiral waveguides 3001 with linearly incremental lengths. The two layers of silicon nitride waveguides are arranged in a vertical direction with waveguide widths and heights corresponding to the Y-branch structure 2001. There are two supermodes in the double-layer spiral waveguide, the even mode and the odd mode. Because the even mode and the odd mode have different group index, different optical path differences at the output port are OPDᵢ=Lᵢ(n_{gO}−n_{ge}), where n_{go} and n_{ge} are the group indices of the odd and the even modes excited in the double-layer spiral waveguide, respectively. Lᵢ is the length of the i^{th} spiral waveguide, which is 600×iμm. As the length of the double-layer spiral waveguide increments linearly, the optical path difference of the odd and even modes also increments linearly.

The resulting output optical signal is measured by the germanium-silicon detectors, which are connected to the output port of the double-layer spiral waveguides to convert the optical power signal into electrical signal.

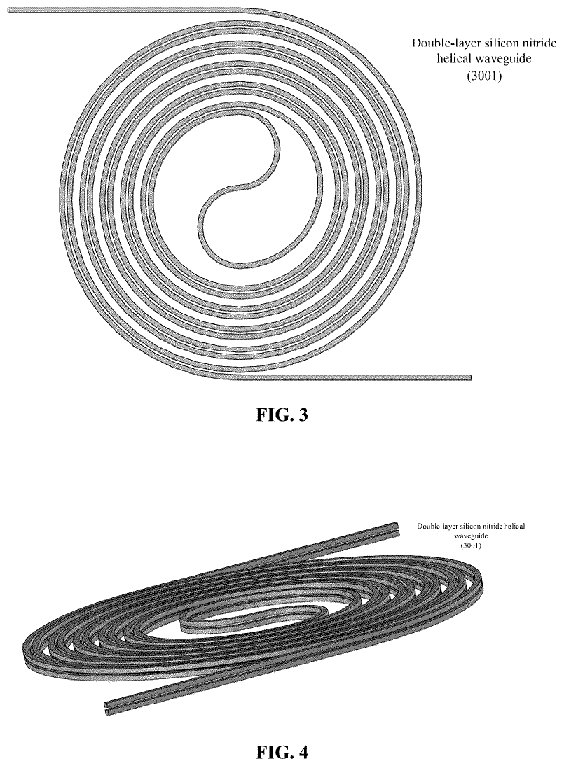

On the basis of the above scheme, the structure of the double-layer spiral waveguide is shown in FIG. 3. To eliminate temperature sensitivity, silicon nitride with a low thermo-optic coefficient is used when selecting the material. The optical path difference for this design is OPDᵢ=Lᵢ(n_{gO}−n_{ge}), n_{go} and n_{ge} are the group indices of the odd and even mode excited in the double-layer spiral waveguide respectively. Lᵢ is the i^{th} spiral waveguide length. Thus, the expression for the temperature dependent phase difference of the double-layer spiral waveguide is

$$\frac{\partial {Δ PHASE}_{i}}{\partial T} = \frac{\partial Δ {n}_{eff}}{\partial T} {L}_{i} ,$$

where Δn_{eff} represents the effective refractive index difference n_{effO}−n_{effe} of the odd and even modes, and hence s

$$\frac{\partial Δ {n}_{eff}}{\partial T}$$

is the thermo-optic coefficient difference of the odd and even modes in the silicon nitride waveguide. The input light is coupled from a lower waveguide into the double-layer spiral waveguide and excites the odd and even modes. Since the even and odd modes are similarly distributed in the upper and lower waveguide and the thermo-optic coefficients of the two modes are similar in the silicon nitride waveguide,

$$\frac{\partial Δ {n}_{eff}}{\partial T}$$

is smaller, thereby achieving the temperature insensitivity.

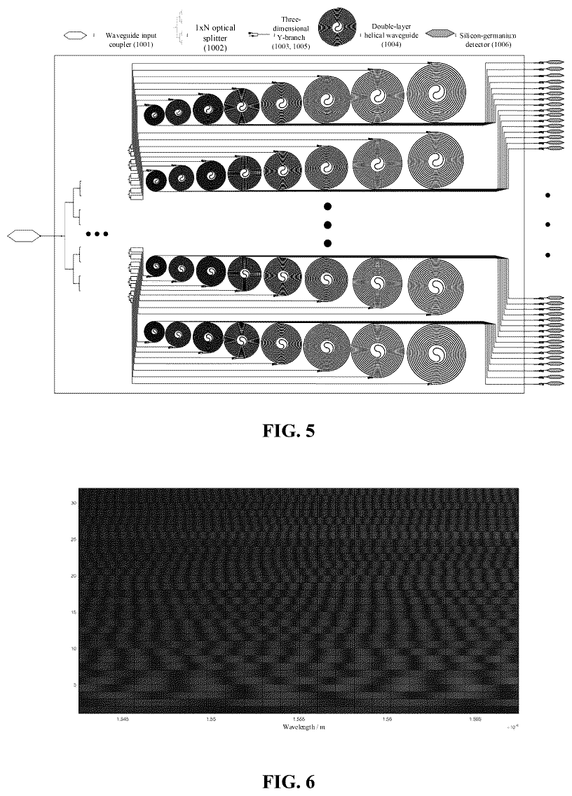

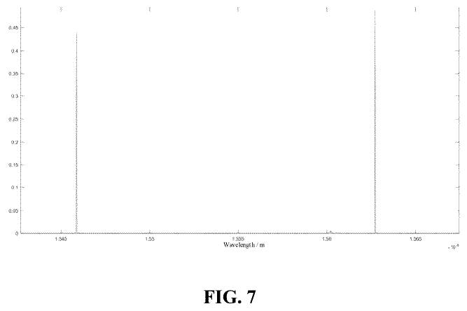

Based on the above protocol, the Fourier transform spectrometer is required to be calibrated to obtain a calibration matrix before testing. A monochromatic light from a tunable laser source is input to the input end of the chip to obtain 32 output interference light. The optical power values of these interference lights are measured to obtain 32 optical power values as the column of the calibration matrix. The calibration matrix A is obtained by tuning the wavelength of the monochromatic light, performing a step-by-step spectrum scanning, and testing a total of m different wavelengths to obtain a 32×m matrix, and normalizing the matrix. As shown in FIG. 5, the wavelength ranges from 1562.5 nm to 1577.5 nm with a step size of 0.015 nm. In the case, the recovery of the wavelength is converted into solving a solution of the formula y=Ax, where x is the polychromatic light to be measured; and y is a measured interference pattern, which is a vector with 32 elements. The ratio of the corresponding element in the vector represents the ratio of the monochromatic light of the corresponding wavelength in the polychromatic light to be measured. Therefore, the spectral information of the polychromatic light to be measured can be recovered when x is solved from y.

As the number of double-layer spiral waveguides is limited, much smaller than the number m of wavelengths used for spectrum sweeping, and the x solution in the matrix equation is not unique. The present invention employs machine learning algorithms to accurately reconstruct the spectrum to be measured. As the spectrum to be measured has sparsity (only a few discrete wavelength components) or continuous spectrum, different algorithms should be used in order to fit for different situation. L₁ norm term is mainly used to increase the sparsity, and L₂ norm term is mainly used to increase the smoothness of the amplitude. These two terms have good effect on reconstructing the sparse spectrum. However, due to the lack of constraints on spectral continuity, only inclusion of the L₁ and L₂ norm terms cannot accurately recover a continuous spectrum. The introduction of the L₂ norm term of a first order difference matrix D₁x to the spectrum may increase the spectral continuity to some extent. Therefore, among the above several algorithms, different kinds of spectra may be reconstructed accurately by using the algorithm Elastic—D1. However, the computational complexity increases due to the need to compute the values of three superparameters α₁-α₃. However, the terms in the algorithm are greater than zero and can be calculated using standard convex optimization tools. FIG. 6 shows a typical recovered spectrum of the incident light using an algorithm Lasso with 1:1 optical power of two monochromatic lights.

TABLE 1

| Algorithm name | Solving a problem |
|---|---|
| Ridge | minₓ{\|\|y − Ax\|\|₂² + α₂ \|\|x\|\|₂²} |
| Lasso | minₓ{\|\|y − Ax\|\|₂² + α₁ \|\|x\|\|₁} |
| BPDN | minₓ{0.5 × \|\|y − Ax\|\|₂² + α₁ \|\|x\|\|₁} |
| RBF Network | ${min}_{c} \{ {‖ y - A {h}_{c} ‖}_{2}^{2} \} , {h}_{c} = Kc = {\sum }_{d = 1}^{D} {C}_{d} {e}^{- β {\vert λ - {λ}_{d} \vert}^{2}}$ |
| Elastic-Net | min_{x, x>0}{\|\|y − Ax\|\|₂² + α₁ \|\|x\|\|₁ + |
| | α₂ \|\|x\|\|₂²} |
| Elastic-D1 | min_{x, x>0}{\|\|y − Ax\|\|₂² + α₁ \|\|x\|\|₁ + |
| | α₂ \|\|x\|\|₂² + α₃ \|\|D₁x\|\|₂²} |

Experiments have shown that the invention satisfies the application need for miniaturization and portability of Fourier transform spectrometers and addresses the temperature sensitivity of existing spectrometers on the silicon platform.

The above-mentioned content is a specific implementation of the Fourier transform spectrometer chip on the silicon platform of the present invention, which can be easily understood by a person skilled in the field of scientific research or industrial sectors. The above mentioned are only preferred embodiments of the present invention and is not intended to limit the invention. Any modification, equivalent substitution and improvement made within the spirit and principles of the invention shall be covered by the protection of the present invention.

1: An on-chip Fourier transform spectrometer based on a double-layer spiral waveguide, comprising
a waveguide input coupler (1001),
a 1×N optical splitter (1002),
N double-layer waveguide Y-branch structures (1003),
N double-layer spiral waveguides (1004),
N double-layer waveguide Y-branch structures (1005) arranged in opposite directions, and
N germanium-silicon detectors (1006);
wherein an output end of the waveguide input coupler (1001) is connected to an input end of the 1×N optical splitter (1002);
N output ends of the 1×N optical splitter (1002) are respectively connected to an input end of the N double-layer waveguide Y-branch structures (1003);
output ends of the N double-layer waveguide Y-branch structures (1003) are connected to input ends of the N double-layer spiral waveguides (1004);
output ends of the N double-layer spiral waveguides (1004) are connected to input ends of N double-layer waveguide Y-branch structures (1005) arranged in opposite directions;
one output end of the N double-layer waveguide Y-branch structures (1005) arranged in opposite directions is connected to an input end of the N germanium-silicon detectors (1006);
the N double-layer spiral waveguides (1004) are composed of N double-layer spiral waveguides (3001) with linearly incremental lengths;
the two layers of waveguides of each double-layer spiral waveguide are parallel to each other, and the width and height of each double-layer spiral waveguide are consistent with the width and height of the corresponding double-layer waveguide Y-branch structure; and
the double-layer spiral waveguides have even and odd modes with different group index so that the output ends have different optical path differences OPDᵢ=Lᵢ(n_{gO}−n_{ge}), wherein n_{go} and n_{ge} are group indices of the odd mode and even mode excitated in the double-layer spiral waveguide respectively, and Lᵢ is the length of an i^{th} double-layer spiral waveguide.

2: The on-chip Fourier transform spectrometer based on the double-layer spiral waveguide according to claim 1, wherein the waveguide input coupler (1001), the 1×N optical splitter (1002), N dual-layer waveguide Y-branch structures (1003), N dual-layer spiral waveguides (1004), N dual-layer waveguide Y-branch structures (1005) arranged in opposite directions, and N germanium-silicon detectors (1006) are integrated in a silicon-on-insulator material, and the waveguides are made from a silicon nitride material.

3: The on-chip Fourier transform spectrometer based on the double-layer spiral waveguide according to claim 1, wherein the waveguide input coupler (1001) adopts a butt-coupling structure or an optical grating structure; and
an optical spectral signal to be measured is input into the chip by an optical fiber.

4: The on-chip Fourier transform spectrometer based on the double-layer spiral waveguide according to claim 1, wherein the 1×N optical splitter (1002) achieves an equal division of the incident optical power by using a cascaded 1×2 splitter structure of log₂N stages, or using a 1×N multi-mode interference structure.

5: The on-chip Fourier transform spectrometer based on the double-layer spiral waveguide according to claim 4, wherein the 1×2 splitter structure is a Y-branch, directional coupler or multi-mode interferometer (MMI) structure.

6: The on-chip Fourier transform spectrometer based on the double-layer spiral waveguide according to claim 1, wherein the N double-layer waveguide Y-branch structures (1003) and the N double-layer waveguide Y-branch structures (1005) arranged in opposite directions are both composed of N double-layer waveguide Y-branch structures (2001) with the same structure;
the Y-branch structures (2001) are composed of upper and lower waveguides with same width and thickness and are parallel to each other at a beam combination position, and the double-layer waveguides together constitute a beam combination end (2002); and
the upper and lower vertical waveguides are gradually separated at the branch in the horizontal direction, each becoming a single-layer waveguide (2003, 2004), achieving the splitting of incident light and the conversion of the waveguide from a double layer to a single layer.

7: The on-chip Fourier transform spectrometer based on the double-layer spiral waveguide according to claim 1, wherein the N germanium-silicon detectors (1006) convert optical power signals into electrical signals by germanium-silicon PIN structures.

8: The on-chip Fourier transform spectrometer based on the double-layer spiral waveguide according to claim 1, wherein the N double-layer waveguide Y-branch structures (1003), N double-layer spiral waveguides (1004) with incremental lengths and N double-layer waveguide Y-branch structures (1005) arranged in opposite directions are similar to an asymmetric Mach-Zehnder interferometer array structure with incremental optical path differences that function as a Fourier transform spectrometer;
the double-layer spiral waveguide array constitutes an array of interferometer structure with different optical path differences; and
the optical path difference variation is introduced by the variation of the spiral waveguide length.
